(19) United States
(12) Patent Application Publication
(10) Pub. No.: US 2026/0351804 A1
(43) Pub. Date: Nov. 5, 2026

(54) PHYSICALLY AND ELECTRICALLY CONFIGURABLE BATTERY PACK

(71) Applicant: Corvus Energy Inc., Richmond (CA)

(72) Inventors: Siu Lun Isaac Tang, Richmond (CA); Jeremy Lindstrøm, Surrey (CA)

(21) Appl. No.: 19/487,398

(22) PCT Filed: May 24, 2023
(86) PCT No.: PCT/CA2023/050711

§ 371 Date: Nov. 24, 2025

(51) Int. Cl. H01M 50/514; H01M 10/42; H01M 10/6563; H01M 10/6567; H01M 50/507; H01M 50/51

(52) U.S. Cl. CPC H01M 50/514; H01M 10/425; H01M 10/6563; H01M 10/6567; H01M 50/507; H01M 50/51; H01M 2010/4278

(57) ABSTRACT

A battery pack and method of installing same. The battery pack has one or more battery stacks, with each stack having stacked modules. The stacked modules include a stack interface module, one or more battery modules, and one or more string disconnect modules (SDMs). Each SDM is located in one of the stacks, is connected to a battery string composed of one or more serially-connected battery modules, and is configured to selectively connect or disconnect each battery module in the battery string. At least one of SDMs for any given stack is separated from the stack interface module of that stack by at least one of the battery modules of that stack.

### TECHNICAL FIELD

The present disclosure is directed at a battery pack that is physically and electrically configurable. More particularly, the present disclosure is directed at a battery pack comprising at least one battery module stack and at least one string disconnect module in the at least one battery module stack, with the at least one string disconnect module configured to disconnect battery strings comprising serially-connected battery modules from each other.

### BACKGROUND

The rise of electrification in consumer and industrial applications has increased the need for energy storage and, more particularly, batteries. Factors such as battery capacity, battery type, battery pack design, and operating conditions can all affect storage capacity and battery performance.

In certain applications, one factor that can also affect available storage and maximum pack voltage or current is the shape of the volume in which the battery pack is to be located when in use. If the volume is particularly constrained, limitations in the electrical and physical configurations of the battery pack may limit the number of battery modules that can physically be installed and/or impede the ability to suitable electrically connect the installed modules, thereby restricting the battery pack's energy storage density, maximum voltage, and/or maximum current.

### SUMMARY

According to a first aspect, there is provided a battery pack comprising: one or more battery stacks, each stack comprising stacked modules including: a stack interface module; and one or more battery modules; one or more string disconnect modules (SDMs), wherein each SDM: is located in a stack of the one or more stacks; is connected to a battery string comprising one or more serially-connected battery modules of the battery pack; and is configured to selectively connect or disconnect the one or more battery modules in the battery string, wherein at least one of the one or more SDMs is separated, from the stack interface module of the stack in which is located the at least one SDM, by at least one of the one or more battery modules of the stack.

For at least one stack, the stack interface module may be at the bottom of the at least one stack and the one or more battery modules may be above the stack interface module.

The battery pack may further comprise one or more pack controllers configured to control the operation of each battery module in the battery pack by communicating with each battery module.

The one or more pack controllers may be further configured to control the operation of each battery module and each SDM in the battery pack by communicating with each battery module and each SDM via the stack interface module of the stack in which is located the battery module or the SDM.

The one or more pack controllers may be configured to communicate with each battery module and each SDM by: the one or more pack controllers sending a communication to the stack interface module of the stack in which is located the battery module or the SDM; and the stack interface module forwarding the communication to the battery module or the SDM.

The one or more battery stacks may include a first stack and a second stack; at least one of the one or more battery strings may comprise: one or more first battery modules in the first stack; and one or more second battery modules in the second stack; and the topmost battery module of the one or more first battery modules may be connected to the bottommost battery module of the one or more second battery modules.

The topmost battery module of the one or more first battery modules in the first stack may not be the topmost battery module of all battery modules in the first stack.

The topmost battery module of the one or more first battery modules may be connected to the bottommost battery module of the one or more second battery modules via the stack interface base of the first stack and via the stack interface base of the second stack.

The topmost battery module of the one or more first battery modules may be connected to the stack interface base of the first stack using a flexible power connector.

The one or more battery stacks may include a first stack and a second stack; and the second stack may be: horizontally adjacent the first stack such that a side of the first stack is adjacent a side of the second stack; or back-to-back adjacent the first stack such that a rear of the first stack is adjacent a rear of the second stack.

For at least one stack, the topmost battery module of the stack may be connected to the stack interface module of the stack using a flexible power connector.

The one or more battery stacks may include a first stack and an adjacent second stack; and the stack interface base of the first stack may be connected to the stack interface base of the second stack using a power connector.

For at least one battery string: the at least one battery string may be wholly contained within a single stack of the multiple stacks, and the single stack may comprise the SDM connected to the at least one battery string; and the one or more serially-connected battery modules of the at least one battery string may consist of: each battery module stacked above the SDM connected to the at least one battery string; and the topmost battery module of the single stack.

For at least one battery string: the at least one battery string may be split across at least a first stack and a second stack, in which the first stack comprises the SDM connected to the at least one battery string and at least one other SDM, and in which the second stack comprises at least one SDM; and the one or more serially-connected battery modules of the at least one battery string may consist of: in the first stack, each battery module stacked above the SDM connected to the at least one battery string and below the at least one other SDM; and in the second stack, each battery module below the at least one SDM of the second stack.

Pairs of vertically-adjacent modules may be connected using power connectors.

In each stack, each module may comprise one or more optical communication ports optically coupled to the one or more optical communication ports of a vertically-adjacent module.

In each stack, the stack interface module may comprise one or more digital communication ports communicatively coupled to the one or more digital communication ports of the stack interface module of an adjacent stack.

The one or more digital communication ports may comprise one or more Ethernet ports.

The battery pack may further comprise: one or more pack controllers configured to control the operation of each battery module in the battery pack by communicating with each battery module, in which the one or more pack controllers may be further configured to control the operation of each battery module and each SDM in the battery pack by communicating with each battery module and each SDM via the stack interface module of the stack in which is located the battery module or the SDM, and in which the one or more pack controllers are communicatively connected to each stack interface module via the one or more digital communication ports.

The one or more battery stacks may include a first stack and a second stack; and the stack interface module of the first stack may be in a different horizontal plane to the stack interface module of the second stack.

At least one battery module of the battery pack may comprise one or more fans for air-cooling the battery module.

The battery pack may further comprise one or more liquid-cooling systems for liquid-cooling at least one battery module of the battery pack.

In at least some aspects, no stack may comprise more than two SDMs. Alternatively, in at least some aspects at least one stack may comprise at least two SDMs.

At least one battery string may comprise an electrical safety shut-down path connecting the SDM of the battery string to each battery module in the battery string.

The stack interface module of at least one of the battery stacks may comprise: at least one DC bus terminal for respectively receiving at least one electrical connector; and at least one battery-side terminal electrically coupled to the one or more battery modules of the at least one of the battery stacks. The at least one DC bus terminal may be movable relative to the at least one battery-side terminal between open and closed positions such that when in the closed position the at least one electrical connector is electrically coupled to the at least one battery-side terminal when received by the at least one DC bus terminal and when in the open position an air gap electrically isolates the at least one electrical connector from the at least one battery-side terminal when received by the at least one DC bus terminal.

The at least one DC bus terminal and the at least one battery-side terminal may be axially movable relative to each other, and the stack interface module of the at least one of the battery stacks may further comprise a screw connected to the at least one DC bus terminal that controls an axial position of the at least one DC terminal relative to the at least one battery-side terminal.

According to another aspect, there is provided a method of installing a battery pack, comprising: installing one or more battery stacks by, for each stack, stacking modules including: a stack interface module; and one or more battery modules; during the installation of the one or more stacks, installing one or more string disconnect modules (SDMs) by including each SDM in a stack of the one or more stacks, wherein: each SDM is connected to a battery string comprising one or more battery modules of the battery pack; each SDM is configured to selectively connect or disconnect each battery module in the battery string; and at least one of the one or more SDMs is separated from the stack interface module of the stack in which is located the at least one SDM by at least one of the one or more battery modules of the stack.

This summary does not necessarily describe the entire scope of all aspects. Other aspects, features and advantages will be apparent to those of ordinary skill in the art upon review of the following description of specific embodiments.

### BRIEF DESCRIPTION OF THE DRAWINGS

In the accompanying drawings, which illustrate one or more example embodiments:

FIG. 1 is a perspective view of a battery pack, according to an example embodiment.

FIG. 2 is a perspective view of a battery pack contained within a ship's hull, according to an example embodiment.

FIGS. 3 to 5 depict schematics of different battery pack configurations, according to example embodiments.

FIG. 6 is a schematic of a battery pack, according to an example embodiment.

FIG. 7 is a schematic of two battery modules stacked on top of each other, according to an example embodiment.

FIG. 8 is a schematic of a battery module stacked on top of a stack interface module, according to an example embodiment.

FIG. 9 is a schematic depicting how a pack controller communicates with a number of stack interface modules, according to an example embodiment.

FIGS. 10A to 10C are respectively perspective, top plan, and sectional views of first and second string ports comprising part of a stack interface module, according to an example embodiment.

### DETAILED DESCRIPTION

In industrial applications, such as marine applications, the volume in which a battery pack is to be installed may be irregularly shaped or otherwise particularly constrained. For example, in a marine application the volume available for battery pack installation may be adjacent the side of a ship's hull, which is curved and not designed to efficiently house stacks of rectangular battery modules. This can make physically and electrically configuring a battery pack so that it can make efficient use of available space while satisfying power and energy density demands difficult.

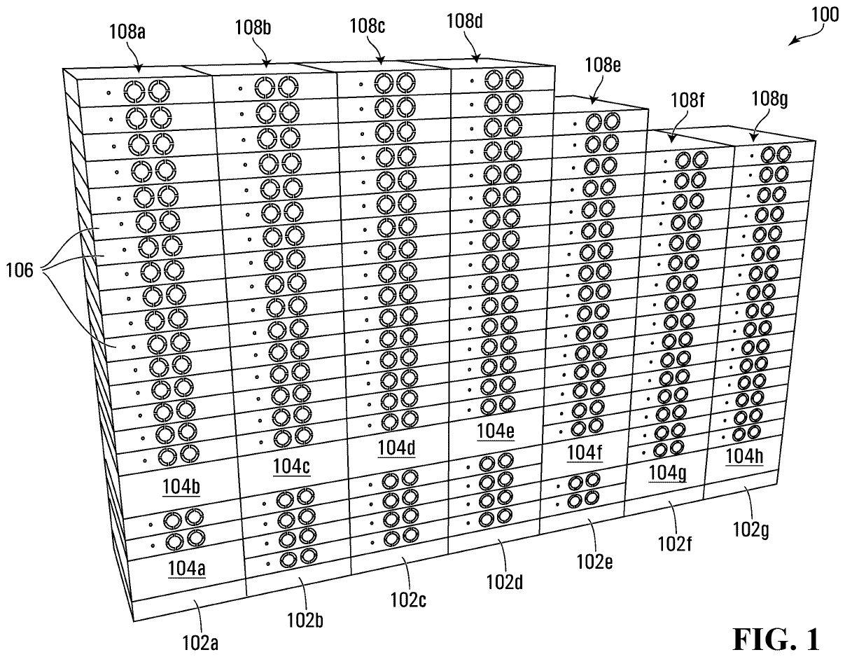

An example battery pack 100 such as that depicted in FIG. 1 is designed to be electrically and physically configurable so as to be able to provide the requisite energy density and power requirements within an irregularly shaped physical volume. The pack 100 comprises first through seventh module stacks 108a-g (generally, “module stacks 108”) that are electrically connected together. At the bottom of the first through seventh stacks 108a-g are first through seventh stack interface modules 102a-g (generally, “stack interface modules 102”), respectively. First and second string disconnect modules (each an “SDM”) 104a,b (generally, “SDMs 104”) are located in the first stack 108a, while third through eighth SDMs 104c-h are respectively located in the second through seventh stacks 108b-g. The remaining modules of the battery pack 100 are battery modules 106 that comprise battery cells (not depicted in FIG. 1). Each of the battery modules 106 comprises part of one of a number of different battery strings (not labeled in FIG. 1), with the modules 106 of any one of the battery strings being electrically connected in series with each other.

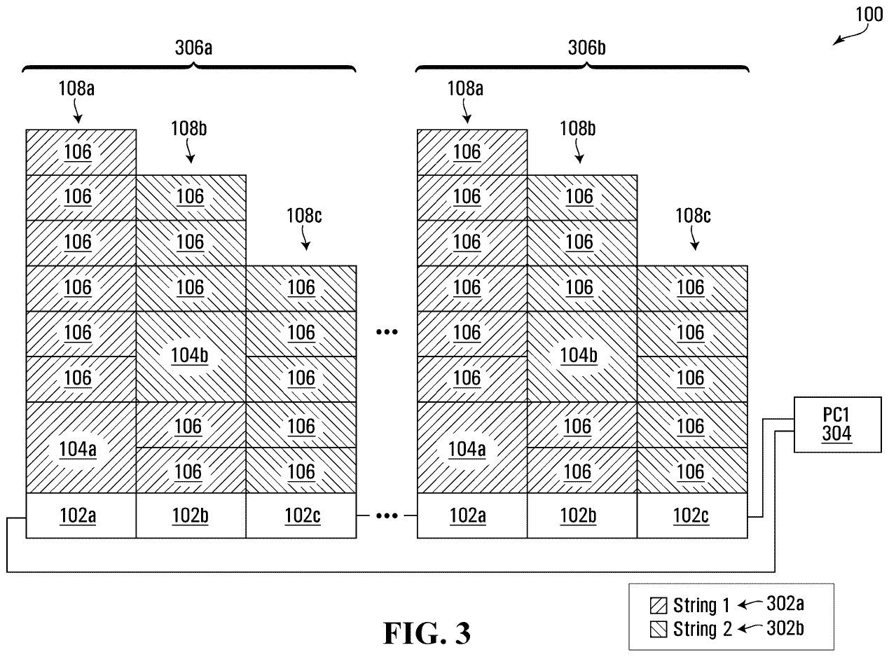

As discussed further below in respect of FIGS. 3 to 6, the SDMs 104 permit battery strings of one or more different maximum voltages to be constructed using stacks 108 of varying heights by permitting selective connection and disconnection of respective battery strings. For example, a battery string may span multiple stacks 108, thereby permitting battery modules 106 to be connected in series to create a battery string having a voltage higher than if all battery modules 106 of a particular string had to be confined to a single stack 108. Additionally, the SDMs 104 may be used to separate different strings from each other on the same stack 108; this permits a single stack 108 to comprise multiple strings, thereby helping to increase the pack's 100 energy density within a constrained volume. The stacks 108a-g of FIG. 1 and FIGS. 3 to 6 are horizontally adjacent in that a side of any of the stacks 108 is adjacent a side of a neighboring stack.

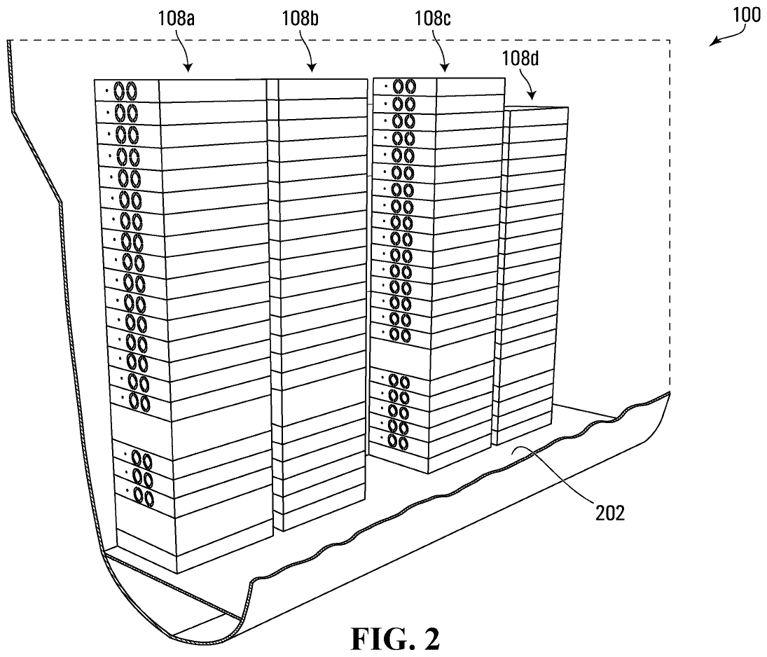

FIG. 2 is a perspective view of a battery pack 100 contained within a ship's hull 202, according to an example embodiment. The battery pack 100 of FIG. 2 comprises first through fourth module stacks 108a-d, in which the first through third stacks 108a-c are the same height and the fourth stack 108d is a shorter height. This height differential helps the battery pack 100 to fit within the constrained volume delineated by the curved ship's hull 202. The stacks 108a-d of FIG. 2 are back-to-back adjacent in that a rear of any one of the stacks 108a-d is adjacent a rear of a neighboring stack 108a-d. This facilitates access to the front sides of all the stacks 108a-d.

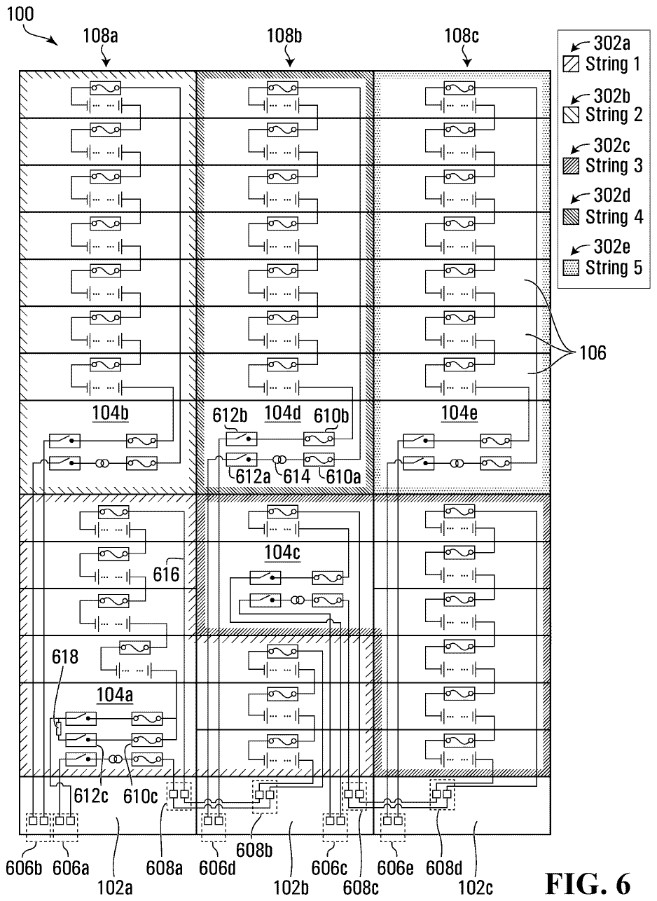

FIG. 6 depicts a schematic of an example battery pack 100, according to an example embodiment. The pack 100 of FIG. 6 comprises first through third stacks 108a-c at the bottom of which are first through third stack interface bases 102a-c, respectively. The pack 100 also comprises first through fifth strings 302a-e that are respectively electrically connected with or disconnected from the rest of the pack 100 via first through fifth SDMs 104a-e. The first SDM 104a rests directly on the first stack interface base 102a; the second SDM 104b is the sixth module on the first stack interface base 102a; the third SDM 104c is the fourth module on the second stack interface base 102b; the fourth SDM 104d is the sixth module on the second stack interface base 102b; and the fifth SDM 104e is the sixth module on the third stack interface base 102c. The modules in the pack 100 that are not the SDMs 104a-e or stack interface bases 102a-c are battery modules 106 that comprise battery cells (i.e., power sources).

Each of the battery modules 106 is electrically modeled as comprising first and second terminals, with battery cells 602 and a fuse 604 electrically connected in series between the first and second terminals. While a single fuse 604 is schematically depicted in each of the battery modules 106 of FIG. 6, in various embodiments each of the modules 106 may comprise a single fuse for all of the cells 602, multiple fuses 604 for each of the cells 602 (e.g., one fuse 604 per cell 602), and/or a different overcurrent protection device in place of the fuse 604 such as a breaker. Additionally, in at least some other embodiments (not depicted), any one or more of the battery modules 106 may lack any overcurrent protection device.

Each of the SDMs 104a-e is a two-port network with the first port comprising first and third terminals, and the second port comprising second and fourth terminals. A first fuse 610a and a first switch 612a are connected in series between the first and third terminals, with a DC power source 614 modeling the DC current conducted from the third terminal to the first terminal that is drawn from the battery modules 106 electrically connected to the SDM 104. A second fuse 610b and a second switch 612b are analogously electrically connected in series between the second and fourth terminals. As described above in respect of the battery module's 106 fuse 604, in at least some example embodiments one or both of the fuses 610a,b of the SDMs 104 may be replaced with a different type of overcurrent protection device or omitted entirely.

Collectively, the first through third stack interface modules 102a-c comprise first through fifth string ports 606a-e that respectively output power from the first through fifth strings 302a-e. Each of the first through fifth string ports 606a-e comprises a pair of positive and negative terminals, with one of the terminals electrically connected to a first module 106 comprising part of the respective string 302a-e and the other of the terminals electrically connected to a last module 106 comprising part of the respective string 302a-e. The string ports 606a-e are generally electrically connected to a DC power bus (not shown) to provide access to the DC power generated by the battery pack 100.

The first SDM 104a further comprises a pre-charge circuit, with the pre-charge circuit connected in parallel with the second fuse 610b and second switch 612b. The pre-charge circuit comprises a resistor 618 connected in series with a pre-charge switch 612c and pre-charge fuse 610c. The resistor 618 may comprise, for example, a standalone resistor or some other type of resistive element. The pre-charge circuit serves to lower the voltage differential between the first string 302a and the DC bus connected to the first string 302a via the first string port 606a, thereby reducing the inrush current to from the first string 302a to the DC bus upon initial connection. While only the first SDM 104a is shown as having a pre-charge circuit in FIG. 6, in at least some other embodiments, none of the SDMs 104 in the battery pack 100 may comprise the pre-charge circuit, or each of two or more SDMs 104 of a battery pack 100 may comprise the pre-charge circuit. Also, as described above in respect of the SDMs' 104 first and second fuses 610a,b, in at least some example embodiments a different type of overcurrent protection device aside from the pre-charge fuse 610c may be used in the pre-charge circuit, or the pre-charge circuit may lack an overcurrent protection device entirely.

All of the modules 104b, 106 comprising the second string 302b are in the first stack 108a (i.e., the second SDM 104b is the sixth module 108a on the stack interface module 102a, and the remaining seven modules 106 of the second string 302b are on top of the second SDM 104b). The seven modules 106 are electrically coupled in series with each other, with the first (positive) terminal of the first module stacked on the second SDM 104b and the second (negative) terminal of the topmost module stacked on the second SDM 104b coupled to the second port (i.e., the second and fourth terminals) of the second SDM 104b via a return conductor 616. The electrical connections between the modules 106, SDMs 104a-e , and stack interface modules 102a-e (including the return conductor 616) may be flexible (e.g., a cable) or rigid (e.g., a bus bar) power connectors. The first port (i.e., the first and third terminals) of the second SDM 104b is electrically coupled to the second string port 606b. The second string port 606b accordingly provides access to a power source comprising the modules 106 of the second string 302b connected in series.

The fourth and fifth strings 302d,e are constructed analogously as the second string 302b except they respectively comprise part of the second and third stacks 108b,c instead of the first stack 108a. The fourth and fifth string ports 606d,e accordingly provide access to the power source comprising the modules 106 of the fourth and fifth strings 302d,e connected in series, respectively.

In contrast to the second, fourth, and fifth strings 302b,d,e, the first string 302a comprises the first SDM 104a and four modules 106 electrically connected in series and stacked between the first and second SDMs 104a,b in the first stack 108a, and the three modules 106 electrically connected in series and stacked between the stack interface module 102b and the third SDM 104c in the second stack 108b. A first cross-stack port 608a in the first stack 108a and a second cross-stack port 608b in the second stack are used to electrically connect the first string's 302a modules 106 in the first and second stacks 108a,b together. Each of the cross-stack ports 608a,b comprises a pair of terminals. As described above in respect of the second string 302b, the first terminal of the first SDM 104a is connected to one of the terminals of the first string port 606a. However, instead of connecting the first string's 302a topmost module 106 directly to the first SDM 104a, it is connected to one of the terminals of the first cross-stack port 608a. That terminal is connected to a corresponding terminal of the second cross-stack port 608b, which in turn is connected to a first terminal of the first string's 302a bottommost module 106 in the second stack 108b. The second terminal of the first string's 302a topmost module in the second stack 108b is connected to the remaining terminal in the second cross-stack port 608b, which in turn is connected to the remaining terminal in the first cross-stack port 608a, which itself is connected to the remaining terminal in the first string port 606a. From an electrical perspective, then, the first string's 302a topmost module 106 in the second stack 108b is analogous to the second string's 302b topmost module 106 in the first stack 108a, with the first and second cross-stack ports 608a,b used to electrically connect the first string's 302a topmost module 106 in the first stack 108a and bottommost module 106 in the second stack 108b together in series.

Analogous to the first string 302a, the third string 302c also spans two stacks 108b,c. In the second stack 108b, the third string 302c comprises the third SDM 104c and one module 106 stacked directly on it, and the first six modules 106 on the third stack interface module 102c of the third stack 108c. Third and fourth cross-stack ports 608c,d act analogously as the first and second cross-stack ports 608a,b to connect the third string's 302c module 106 in the second stack 108b with the third string's 302c bottommost module 106 in the third stack 108c. The third SDM's 104c first port is connected to the third string port 606c to provide access to power from the third string 302c.

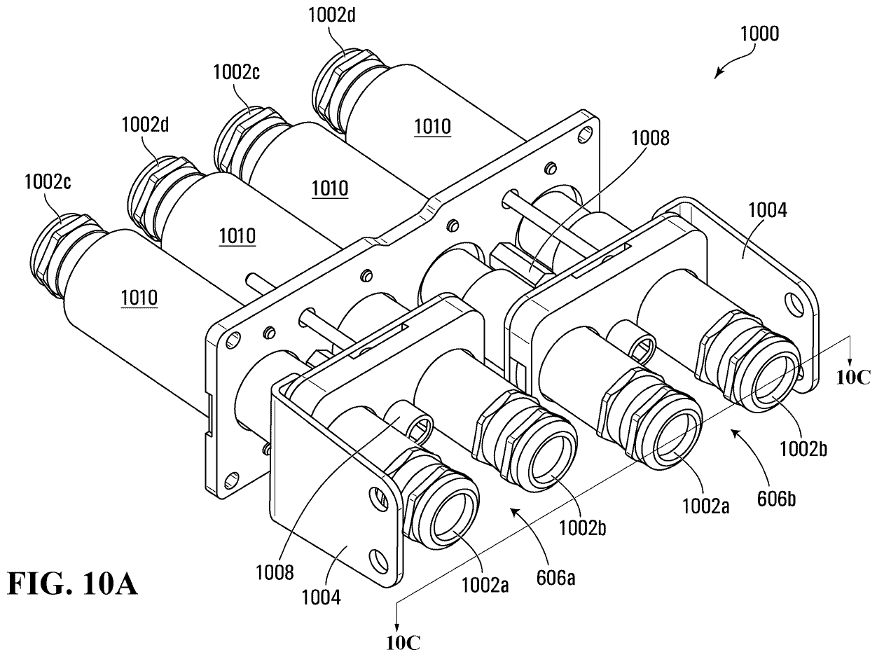

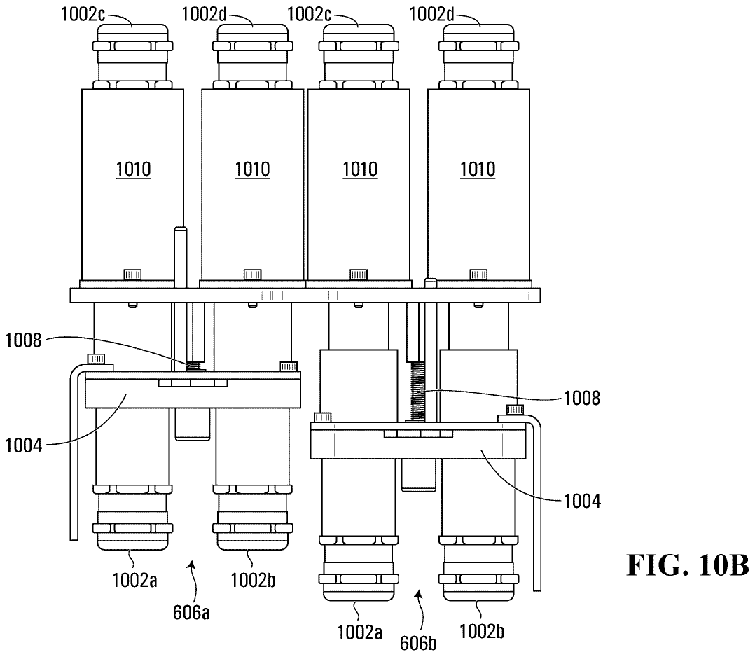

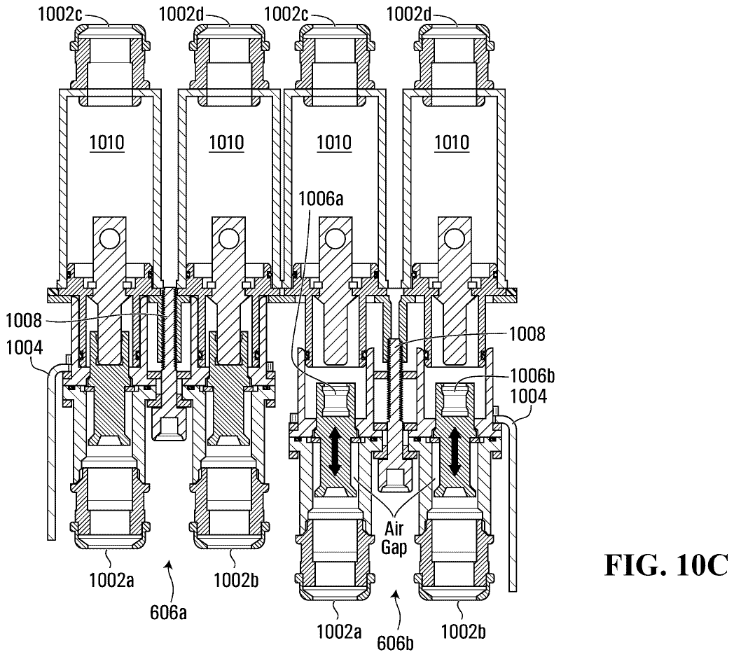

Referring now to FIGS. 10A to 10C, there are respectively depicted perspective, top plan, and sectional views of a port assembly 1000 comprising the first and second string ports 606a,b. The sectional view of FIG. 10C is taken along line 10C-10C of FIG. 10A. While only the first and second string ports 606a,b are depicted in FIGS. 10A to 10C, any one or more of the third through fifth string ports 606a-e may be analogously constructed, and additionally or alternatively any of the cross-stack ports 608 may be analogously constructed.

Each of the string ports 606a,b depicted in FIGS. 10A-10C comprises first and second DC bus terminals 1002a,b for connecting to power conductors such as cables that are electrically coupled to a DC bus (not shown), and first and second battery-side terminals 1002c,d electrically connected via bus bars and/or cabling to the battery modules 106. This permits power to be drawn from the battery modules 106 and delivered to the DC bus, or for power delivered along the DC bus to be delivered to the modules 106 for recharging. The first DC bus terminal 1002a and first battery-side terminal 1002c, and the second DC bus terminal 1002b and second battery-side terminal 1002d are at opposing ends of a cylindrical housing 1010 and are axially aligned with each other.

Each of the first and second DC bus terminals 1002a,b comprises part of a sliding portion 1004 that is axially slidable between open and closed positions. When in the closed position, the DC bus terminals 1002a,b and battery-side terminals 1002c,d are respectively electrically connected together; and when in the open position, the DC bus terminals 1002a,b and battery-side terminals 1002c,d are respectively electrically disconnected. In FIGS. 10A-10C, the first string port 606a is shown in the closed position and the second string port 606b is shown in the open position. The sectional view of FIG. 10C in particular shows that internal to the housings 1010 of the first and second DC bus terminals 1002a,b are respectively first and second electrical contacts 1006a,b. When the DC bus terminals 1002a,b are in the closed position, the front face of the terminals 1002a,b and the contacts 1006a,b are sufficiently close that electrical connectors plugged into the terminals 1002a,b touches and becomes electrically conductive with the contacts 1006a,b. In contrast, when the DC bus terminals 1002a,b are in the open position, the air gap between the front face of the terminals 1002a,b and the contacts 1006a,b is large enough that connectors plugged into the terminals 1002a,b remain electrically isolated from the battery-side terminals 1002c,d.

An actuator in the form of a screw 1008 is used to secure the DC bus terminals 1002a,b in the open and closed positions. As shown in FIGS. 10A-10C, the screw 1008 for each of the string ports 606a,b is affixed to and extends through a plate that is affixed to a movable portion of the first and second DC bus terminals 1002a,b. Rotating the screw accordingly axially moves the DC bus terminals 1002a,b closer to or farther from the battery-side terminals 1002c,d.

While FIGS. 10A-10C depict an example embodiment in which the DC bus terminals 1002a,b are axially movable relative to the battery-side terminals 1002c,d via a screw, in at least some other embodiments different implementations are possible. For example, the DC bus terminals 1002a,b may be pivotable or slidable relative to the battery-side terminals 1002c,d, and instead of a screw a different type of securing device (e.g., a lock or clip) may be used to secure the DC bus terminals 1002a,b in the open or closed positions.

FIGS. 3 to 6 depict schematics of different battery pack configurations, according to example embodiments. FIG. 3 depicts a battery pack 100 comprising identical first and second arrays 306a,b. Each of the arrays 306a,b comprises first through third stacks 108a-c whose bases respectively comprise first through third stack interface modules 102a-c. A first SDM 104a rests directly on the first stack interface module 102a and a second SDM 104b is the third module on the second interface module 102b. A first string 302a comprises the six modules 106 on top of the first SDM 104a and the two modules 106 between the second stack interface module 102b and the second SDM 104b. A second string 302b comprises the three modules 106 stacked on top of the second SDM 104b and all five modules 106 on top of the third stack interface base 102c. Each array 306a,b accordingly comprises two strings 302a,b each comprising six modules 106 connected in series.

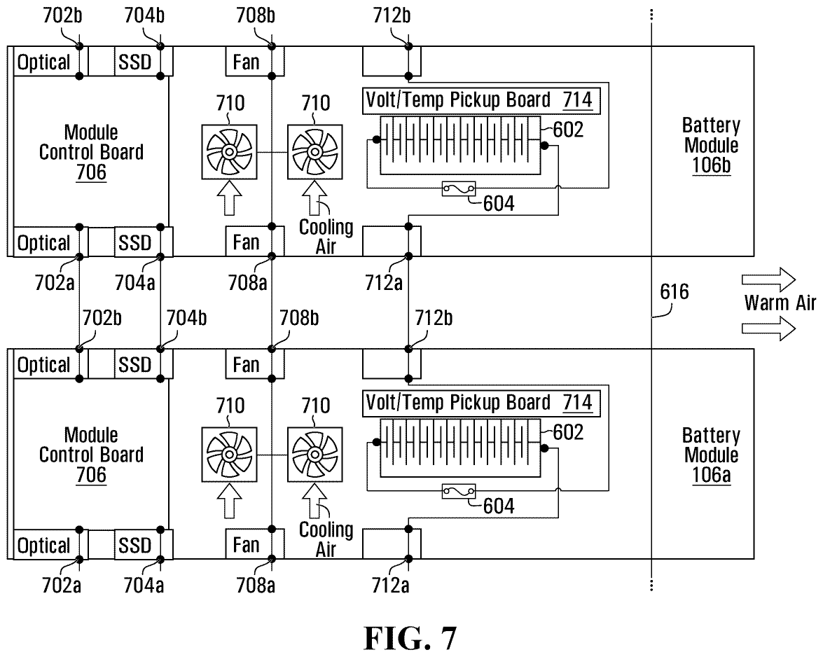

FIG. 3 also comprises a pack controller 304 that is communicatively coupled to the stack interface modules 102a-c of the first and second arrays 306a,b. Control signals from the pack controller 304 are transmitted to the third stack interface module 102c of the second array 306b and propagate to the second stack interface module 102b of the second array 306b, to the first stack interface module 102a of the second array 306b, to the third stack interface module 102c of the first array 306a, to the second stack interface module 102b of the first array 306a, and then to the first stack interface module of the first array 102a 306a. The control signals are able to modulate the switches 612a,b (not shown in FIG. 3) of the SDMs 104a,b of both arrays 306a,b, thereby permitting any of the strings 302a,b of either array 306a,b to be selectively added to or removed from the battery pack 100. The circuitry used to implement the control signals is described in more detail in respect of FIGS. 7 to 9, below.

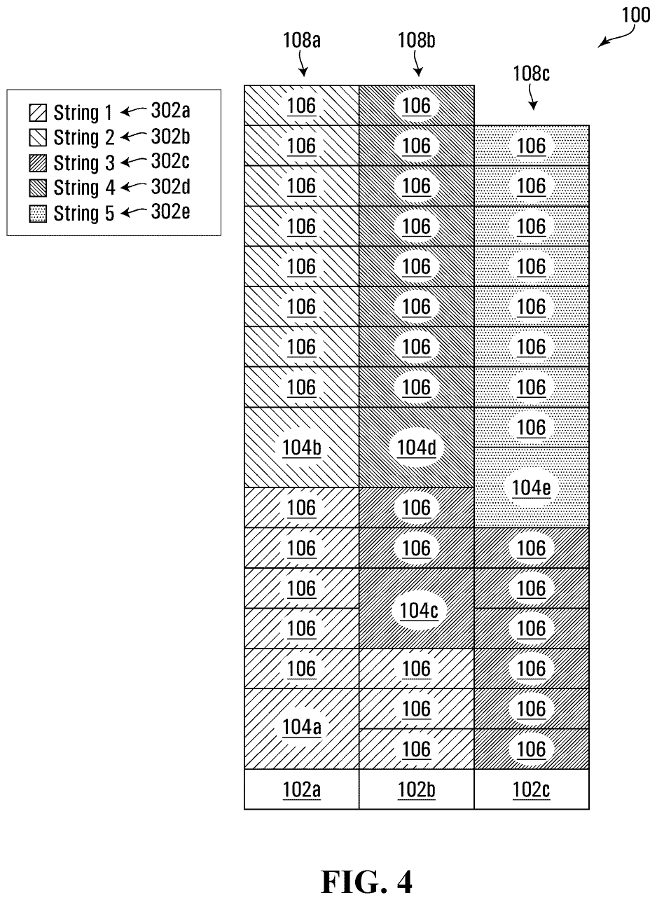

FIG. 4 depicts another battery pack 100 constructed analogously as the packs 100 of FIGS. 3 and 6. More particularly, the pack 100 of FIG. 4 comprises five strings 302a-e spread over three stacks 108a-c, with first through third stack interface modules 102a-c at the base of the stacks 108a-c, respectively. First through fifth SDMs 104a-e are able to electrically connect and disconnect the first through fifth battery strings 302a-e, respectively, to and from the battery pack 100.

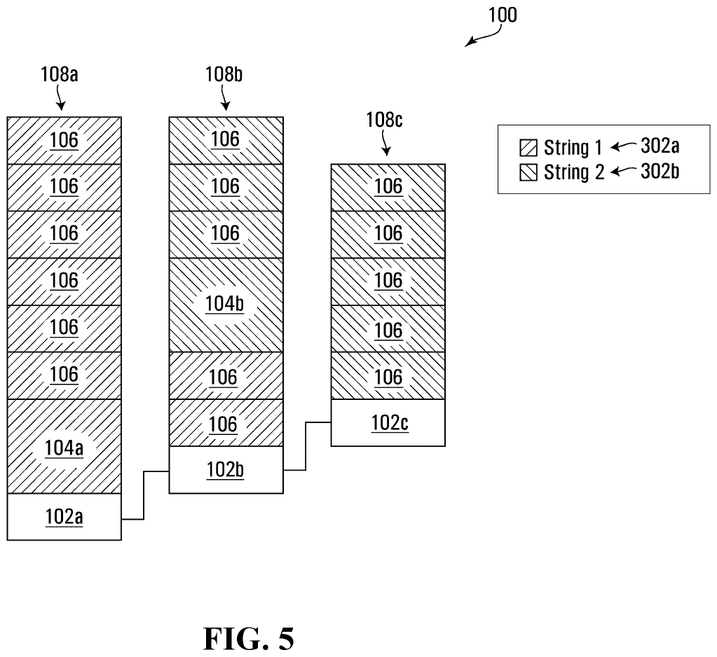

FIG. 5 shows a battery pack 100 comprising first and second strings 302a,b respectively controllable using first and second SDMs 104a,b spread over first through third stacks 108a-c at the base of which are first through third stack interface modules 102a-c, respectively. The stack interface modules 102a-c are electrically connected to each other to permit the first and second strings 302a,b to span the stacks 108a-c and to permit control signals from a pack controller (not shown in FIG. 5) to propagate across the stacks 108a-c as described above in respect of FIG. 4. FIG. 5 shows the three stack interface modules 102a-c at different horizontal planes, emphasizing that the bases of the stacks 108a-c may be located at different heights to accommodate differently shaped volumes in which the pack 100 may be installed. Flexible power and communication connectors are used to respectively electrically and communicatively connect the stack interface modules 102a-c to each other in this embodiment.

FIG. 7 is a schematic of a second battery module 106b stacked on top of a first battery module 106a, according to an example embodiment. The battery modules 106a,b are identical, with each comprising the battery cells 602 and fuse 604; a module control board 706 to receive and process optical and electrical signals; fans 710 for cooling; and a voltage/temperature pickup board 714 for measuring cell voltage and temperature during operation. Each of the modules 106a,b also comprises a first terminal 712a and a second terminal 712b electrically coupled in series with the cells 602; the second terminal 712b of the first module 106a is connected to the first terminal 712a of the second module 106b, thereby electrically coupling the modules 106a,b in series. The conductor 616 is also depicted as extending across both the modules 106a,b in FIG. 7, terminating in either one of the string ports 606 or cross-stack ports 608. Each of the modules 106a,b also comprises input and output optical terminals 702a,b that facilitate optical signal transmission to and from the module control board 706 and input and output fan terminals 708a,b that control whether and how quickly the fans 710 spin and the consequent air cooling of the modules 106a,b. While not depicted, in at least some other embodiments the modules 106a,b may use liquid cooling as an alternative to or in addition to air cooling.

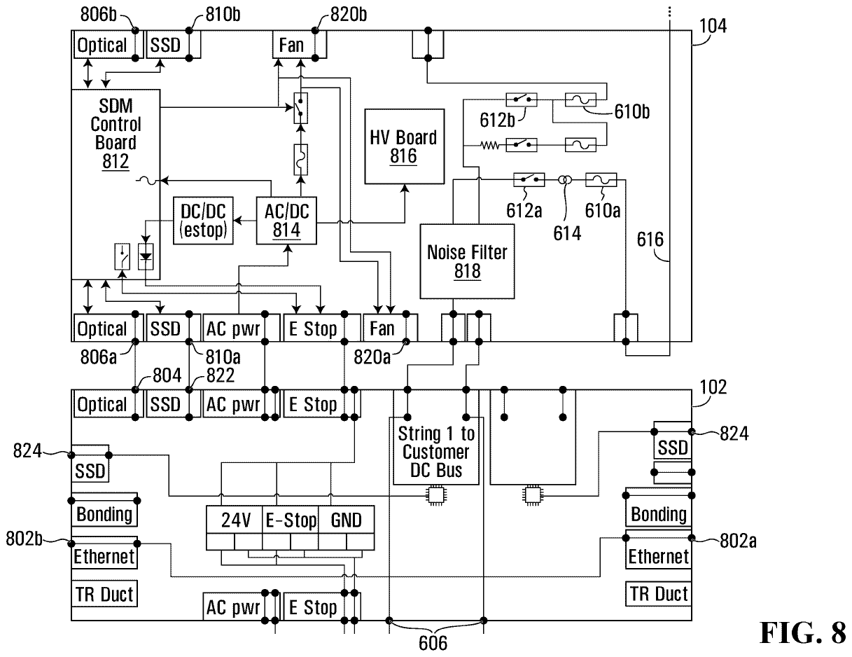

The module control board 706 monitors cell voltage and temperature as obtained via the voltage/temperature pickup board 714 and determines whether one or both of the voltage and temperature measurements indicate that the module 106a,b is in a fault state (e.g., as a result of the measured temperature exceeding a temperature fault threshold or the measured voltage exceed a measured voltage threshold). If either of the modules 106a,b is in a fault state, the module control board 706 for that module 106a,b sends an electrical safety shut-down signal down the stack 108 to the SDM 104, and as discussed further below in respect of FIG. 8 the SDM 104 in response disconnects the battery string that comprises the modules 106a,b by opening one or both of the first and second switches 612a,b.

Additionally or alternatively, in at least some embodiments the module control board 706 for the module 106a,b that enters the fault state sends an electrical safety shut-down signal that propagates up and down the stack 108 so that all of the modules 106 in the stack 108 know of the fault state and can respond accordingly without requiring input from the SDM 104. For example, in at least some embodiments if the second module 106b enters into a fault state, it sends the safety shut-down signal up and down the stack 108 via the safety shut-down terminals 704a,b. The first module 106a, and all of the other modules 106 in the stack 108, may then disconnect their cells 602 for safety purposes without waiting for a message from the SDM 104.

FIG. 8 is a schematic of an SDM 104 stacked on top of a stack interface module 102, according to an example embodiment. The SDM 104 comprises the first and second fuses 610a,b, the first and second switches 612a,b, and the DC power source 614 as described above in respect of FIG. 6. The SDM 104 also comprises the pre-charge circuit described in respect of the first SDM 104a of FIG. 6. The conductor 616 is also depicted extending across the SDM 104 in FIG. 8, terminating in either one of the string ports 606 or cross-stack ports 608.

The SDM 104 further comprises an SDM control board 812, AC/DC converter 814, high voltage board 816, and noise filter 818. The noise filter 818 filters the power delivered to the string ports 606. Analogous to the modules 106a,b of FIG. 7, the SDM 104 also comprises input and output optical terminals 806a,b and safety shut-down terminals 810a,b that respectively facilitate transmission of optical and safety shut-down signals to and from the SDM control board 812. Input and output fan terminals 820a,b transmit signals to the modules 106 to control the fans 710. More particularly, the output optical, safety shut-down, and output fan terminals 806b,810b,820b are respectively coupled to the input optical, safety shut-down, and input fan terminals 702a, 704a, 708a of the module 106 stacked directly on the SDM 104.

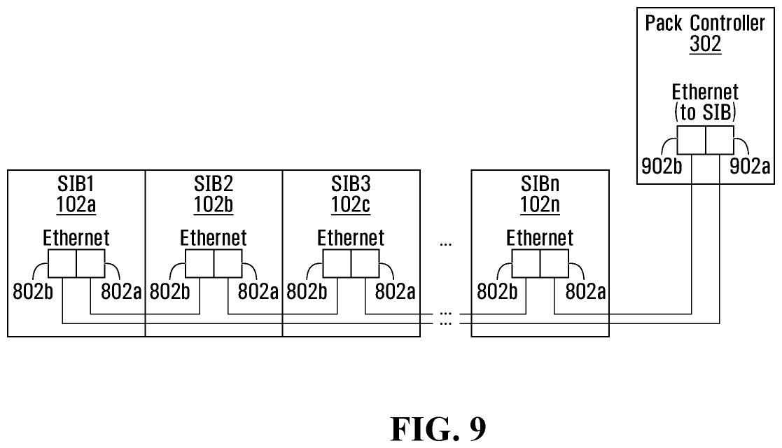

The stack interface module 102 of FIG. 8 comprises the string port 606 to provide access to the power provided by one of the strings 302, and also comprises an output optical terminal 804 and safety shut-down terminal 822 that respectively communicate with the input optical terminal 806a and safety shut-down terminal 810a of the SDM 104 stacked directly on top of the stack interface module 102. The stack interface module 102 of FIG. 8 also comprises an input communication port 802a and output communication port 802b for communicating with the pack controller 304 as described above in respect of FIG. 3 and as described in more detail in FIG. 9 below. While the communication ports 802a,b are Ethernet ports in the depicted embodiment, in different embodiments the communication ports 802a,b may be configured to communicate using any suitable optical or electrical communication protocol, for example.

The combination of the horizontally extending communications ports 802a,b and the vertically extending optical terminals 702a,b, 804,806a,b, 810a,b permit the pack controller 302 to send commands to the stack interface module 102, and the stack interface module 102 to then propagate those commands up the stack 108 via the SDM 104 and battery modules 106. In particular, the electrical communication signal from the pack controller 302 to the stack interface module 102 may be used for communication away from the battery modules 106 where there is relatively little electrical noise, and the optical signal used for transmission up the stacks 108 in closer proximity to the battery modules 106 where electrical noise is more of a concern.

If any of the modules 106 in the stack 108 experiences a fault and performs a safety shut-down, as described above the safety shut-down signal propagates along the stack 108 starting at the module 106 experiencing the fault. The safety shut-down signal eventually reaches the SDM control board 812 of the SDM 104, in response to which the SDM control board 812 opens the first and second switches 610a,b to disconnect the battery string comprising the module(s) 106 that experienced the fault. The safety shut-down signal continues propagating down the stack until it reaches the stack interface module 102. In embodiments in which the stack interface module 102 is one of multiple stack interface modules 102 connected together such as is depicted in FIGS. 1 to 6, the stack interface module 102 that first received the safety shut-down signal vertically forwards it horizontally via the safety shut-down terminals 824 to the other stack interface modules 102. The other stack interface modules 102 upon receiving the safety shut-down signal may send an optical signal via their respective optical terminals 804 to shut down the modules 106 in their respective stacks 108 as well. The stack interface module 102 that first received the safety shut-down signal may also send an electrical message via the communications ports 802a,b to the pack controller 304 notifying the pack controller 304 of the fault.

FIG. 9 is a schematic depicting how the pack controller 302 communicates with a number of the stack interface modules 102a-n, according to an example embodiment. FIG. 9 depicts the pack controller 302 connected to various stack interface modules 102a-n in a ring network. More particularly, the pack controller 302 comprises first and second communication ports 902a,b, with a communication line extending from the pack controller's 302 second communication port 902b to the input communication port 802a of the nth stack interface module 102n. The nth stack interface module then relays the communication signal along the row of stack interface modules 102a-n via its output communication port 802b, until in FIG. 9 the signal reaches the input communication port 802a of the third stack interface module 102c. The signal continues to propagate in this manner until reaching the first stack interface module 102a. The output communication port 802b of the first stack interface module 102a is connected via a return loop to the first communication port 902a of the pack controller 302; while a return loop is not necessary it may be useful for the sake of redundancy. While not depicted in FIG. 9, any of the stack interface modules 102a-n may forward commands up the optical and safety shut-down terminals 702a,b,704a,b,804,806a,b,810a,b,822 (not depicted in FIG. 9) of the modules 104,106 comprising the respective stacks 108 to control pack operation as described above.

While FIG. 9 depicts the pack controller 302 connected to the stack interface modules 102a-n using a ring network, different network topologies are possible in at least some other embodiments. For example, in at least some other embodiments the pack controller 302 may be independently connected to each of the stack interface modules 102a-n, thereby forming a star network. Additionally, the various communication ports 704a,b, 802a,b, 810a,b, 822,902a,b, are digital communication ports in the depicted embodiments, although in at least some alternative embodiments (not depicted) they may be configured for analog communication.

At least some embodiments comprise a method of installing the battery pack 100 described above. One or more battery stacks 108 may be installed, and as depicted in FIGS. 1 to 5 the stacks 108 may be of different heights to accommodate installation in differently shaped volumes. Each stack 108 is installed by stacking battery modules comprising the stack interface module 102 and one or more battery modules 106. During installation of the one or more stacks 108, one or more SDMs 108 are also included in at least one of the stacks 108. Each of the SDMs 108 is connected to a battery string 302 that comprises one or more of the battery modules 106; is configured to selectively connect or disconnect the one or more battery modules 106 of the battery string 302 from the battery pack 100; and at least one of the SDMs 108 is separated from the stack interface module 102 of the stack 108 in which is located the at least one of the SDMs 108 by at least one or more of the battery modules 106 of that stack 108.

The embodiments have been described above with reference to flow, sequence, and block diagrams of methods, apparatuses, systems, and computer program products. In this regard, the depicted flow, sequence, and block diagrams illustrate the architecture, functionality, and operation of implementations of various embodiments. For instance, each block of the flow and block diagrams and operation in the sequence diagrams may represent a module, segment, or portion of code, which comprises one or more executable instructions for implementing the specified action(s). In some alternative embodiments, the action(s) noted in that block or operation may occur out of the order noted in those figures. For example, two blocks or operations shown in succession may, in some embodiments, be executed substantially concurrently, or the blocks or operations may sometimes be executed in the reverse order, depending upon the functionality involved. Some specific examples of the foregoing have been noted above but those noted examples are not necessarily the only examples. Each block of the flow and block diagrams and operation of the sequence diagrams, and combinations of those blocks and operations, may be implemented by special purpose hardware-based systems that perform the specified functions or acts, or combinations of special purpose hardware and computer instructions.

The terminology used herein is for the purpose of describing particular embodiments only and is not intended to be limiting. Accordingly, as used herein, the singular forms “a”, “an”, and “the” are intended to include the plural forms as well, unless the context clearly indicates otherwise. It will be further understood that the terms “comprises” and “comprising”, when used in this specification, specify the presence of one or more stated features, integers, steps, operations, elements, and components, but do not preclude the presence or addition of one or more other features, integers, steps, operations, elements, components, and groups. Directional terms such as “top”, “bottom”, “upwards”, “downwards”, “vertically”, and “laterally” are used in the following description for the purpose of providing relative reference only, and are not intended to suggest any limitations on how any article is to be positioned during use, or to be mounted in an assembly or relative to an environment. Additionally, the term “connect” and variants of it such as “connected”, “connects”, and “connecting” as used in this description are intended to include indirect and direct connections unless otherwise indicated. For example, if a first device is connected to a second device, that coupling may be through a direct connection or through an indirect connection via other devices and connections. Similarly, if the first device is communicatively connected to the second device, communication may be through a direct connection or through an indirect connection via other devices and connections. The terms “and/or”, “at least one of”, and “one or more of” as used herein in conjunction with a list means any one or more items from that list. For example, each of “A, B, and/or C”, “at least one of A, C, and C”, and “one or more of A, B, and C” means A, B, C, A and B, A and C, and B and C.

Any reference to processors or controllers used in the foregoing embodiments may comprise, for example, a processing unit (such as a processor, microprocessor, or programmable logic controller) communicatively coupled to a non-transitory computer readable medium having stored on it program code for execution by the processing unit, microcontroller (which comprises both a processing unit and a non-transitory computer readable medium), field programmable gate array (FPGA), system-on-a-chip (SoC), an application-specific integrated circuit (ASIC), or an artificial intelligence accelerator. Examples of computer readable media are non-transitory and include disc-based media such as CD-ROMs and DVDs, magnetic media such as hard drives and other forms of magnetic disk storage, semiconductor based media such as flash media, random access memory (including DRAM and SRAM), and read only memory.

It is contemplated that any part of any aspect or embodiment discussed in this specification can be implemented or combined with any part of any other aspect or embodiment discussed in this specification.

One or more example embodiments have been described by way of illustration only. This description is being presented for purposes of illustration and description, but is not intended to be exhaustive or limited to the form disclosed. It will be apparent to persons skilled in the art that a number of variations and modifications can be made without departing from the scope of the claims.

1. A battery pack comprising:
one or more battery stacks, each stack comprising stacked modules including:
a stack interface module; and
one or more battery modules;
one or more string disconnect modules (SDMs), wherein each SDM:
is located in a stack of the one or more stacks;
is connected to a battery string comprising one or more serially-connected battery modules of the battery pack; and
is configured to selectively connect or disconnect the one or more battery modules in the battery string,
wherein at least one of the one or more SDMs is separated, from the stack interface module of the stack in which is located the at least one SDM, by at least one of the one or more battery modules of the stack, and
wherein, for at least one battery string:
the at least one battery string is split across at least a first stack and a second stack, wherein the first stack comprises the SDM connected to the at least one battery string and at least one other SDM, and wherein the second stack comprises at least one SDM; and
the one or more serially-connected battery modules of the at least one battery string consist of:
in the first stack, each battery module stacked above the SDM connected to the at least one battery string and below the at least one other SDM; and
in the second stack, each battery module below the at least one SDM of the second stack.

2. The battery pack of claim 1, wherein, for at least one stack, the stack interface module is at the bottom of the at least one stack and the one or more battery modules are above the stack interface module.

3. The battery pack of claim 1, further comprising one or more pack controllers configured to control the operation of each battery module in the battery pack by communicating with each battery module, wherein the one or more pack controllers are further configured to control the operation of each battery module and each SDM in the battery pack by communicating with each battery module and each SDM via the stack interface module of the stack in which is located the battery module or the SDM.

4. (canceled)

5. The battery pack of claim 3, wherein the one or more pack controllers are configured to communicate with each battery module and each SDM by:
the one or more pack controllers sending a communication to the stack interface module of the stack in which is located the battery module or the SDM; and
the stack interface module forwarding the communication to the battery module or the SDM.

6. The battery pack of claim 1, wherein:
the one or more battery stacks include a first stack and a second stack;
at least one of the one or more battery strings comprises:
one or more first battery modules in the first stack; and
one or more second battery modules in the second stack; and
the topmost battery module of the one or more first battery modules is connected to the bottommost battery module of the one or more second battery modules.

7. The battery pack of claim 6, wherein the topmost battery module of the one or more first battery modules in the first stack is not the topmost battery module of all battery modules in the first stack.

8. The battery pack of claim 6, wherein the topmost battery module of the one or more first battery modules is connected to the bottommost battery module of the one or more second battery modules via the stack interface base of the first stack and via the stack interface base of the second stack.

9. (canceled)

10. The battery pack of claim 1, wherein:
the one or more battery stacks include a first stack and a second stack; and
the second stack is:
horizontally adjacent the first stack such that a side of the first stack is adjacent a side of the second stack; or
back-to-back adjacent the first stack such that a rear of the first stack is adjacent a rear of the second stack.

11. (canceled)

12. The battery pack of claim 1, wherein:
the one or more battery stacks include a first stack and an adjacent second stack; and
the stack interface base of the first stack is connected to the stack interface base of the second stack using a power connector.

13. The battery pack of claim 1, wherein, for at least one battery string:
the at least one battery string is wholly contained within a single stack of the multiple stacks, wherein the single stack comprises the SDM connected to the at least one battery string; and
the one or more serially-connected battery modules of the at least one battery string consist of:
each battery module stacked above the SDM connected to the at least one battery string; and
the topmost battery module of the single stack.

14. (canceled)

15. The battery pack of claim 1, wherein, in each stack, each module comprises one or more optical communication ports optically coupled to the one or more optical communication ports of a vertically-adjacent module.

16. The battery pack of claim 1, wherein, in each stack, the stack interface module comprises one or more digital communication ports communicatively coupled to the one or more digital communication ports of the stack interface module of an adjacent stack.

17. (canceled)

18. The battery pack of claim 16, further comprising:
one or more pack controllers configured to control the operation of each battery module in the battery pack by communicating with each battery module,
wherein the one or more pack controllers are further configured to control the operation of each battery module and each SDM in the battery pack by communicating with each battery module and each SDM via the stack interface module of the stack in which is located the battery module or the SDM, and
wherein the one or more pack controllers are communicatively connected to each stack interface module via the one or more digital communication ports.

19. The battery pack of claim 1, wherein:
the one or more battery stacks include a first stack and a second stack; and
the stack interface module of the first stack is in a different horizontal plane to the stack interface module of the second stack.

20. (canceled)

21. (canceled)

22. The battery pack of claim 1, wherein no stack comprises more than two SDMs.

23. The battery pack of claim 1, wherein at least one stack comprises at least two SDMs.

24. The battery pack of claim 1, wherein at least one battery string comprises an electrical safety shut-down path connecting the SDM of the battery string to each battery module in the battery string.

25. The battery pack of claim 1, wherein the stack interface module of at least one of the battery stacks comprises:
at least one DC bus terminal for respectively receiving at least one electrical connector; and
at least one battery-side terminal electrically coupled to the one or more battery modules of the at least one of the battery stacks, wherein the at least one DC bus terminal is movable relative to the at least one battery-side terminal between open and closed positions such that when in the closed position the at least one electrical connector is electrically coupled to the at least one battery-side terminal when received by the at least one DC bus terminal and when in the open position an air gap electrically isolates the at least one electrical connector from the at least one battery-side terminal when received by the at least one DC bus terminal.

26. The battery pack of claim 25, wherein the at least one DC bus terminal and the at least one battery-side terminal are axially movable relative to each other, and wherein the stack interface module of the at least one of the battery stacks further comprises a screw connected to the at least one DC bus terminal that controls an axial position of the at least one DC terminal relative to the at least one battery-side terminal.

27. A method of installing a battery pack, comprising:
installing one or more battery stacks by, for each stack, stacking modules including:
a stack interface module; and
one or more battery modules;
during the installation of the one or more stacks, installing one or more string disconnect modules (SDMs) by including each SDM in a stack of the one or more stacks, wherein:
each SDM is connected to a battery string comprising one or more battery modules of the battery pack;
each SDM is configured to selectively connect or disconnect the one or more battery modules in the battery string; and
at least one of the one or more SDMs is separated from the stack interface module of the stack in which is located the at least one SDM by at least one of the one or more battery modules of the stack, and
wherein installing the one or more SDMs further comprises:
for at least one battery string, splitting the at least one battery string across at least a first stack and a second stack, wherein the first stack comprises the SDM connected to the at least one battery string and at least one other SDM, wherein the second stack comprises at least one SDM, and wherein the one or more serially-connected battery modules of the at least one battery string consist of:
in the first stack, each battery module stacked above the SDM connected to the at least one battery string and below the at least one other SDM; and
in the second stack, each battery module below the at least one SDM of the second stack.
